(19) United States
(12) Patent Application Publication
(10) Pub. No.: US 2015/0143966 A1
(43) Pub. Date: May 28, 2015

(54) Locking Quick Release Protective Cap Assembly For Pocket Tools

(71) Applicants: Andrew Arlin Pischke, Sparta, NJ (US); Arlin Richard Pischke, Sparta, NJ (US)

(72) Inventors: Andrew Arlin Pischke, Sparta, NJ (US); Arlin Richard Pischke, Sparta, NJ (US)

(21) Appl. No.: 14/301,537

(22) Filed: Jun. 11, 2014

Related U.S. Application Data
(60) Provisional application No. 61/834,344, filed on Jun. 12, 2013.

(51) Int. Cl. B25B 23/00; B43K 23/08

(52) U.S. Cl. CPC B25B 23/00; B43K 23/08
USPC 81/488

(57) ABSTRACT

A locking quick release cap for use on styli or small pocket tools that provides protection for styli tips and protects users from exposed sharp tool tips. A stylus or small pocket tool is machined with retaining groove at the tip end, which is inserted into the locking quick release cap. The locking quick release cap includes a spring loaded slide and an internal locking ball that locks into the tool end retaining groove when fully engaged. The fully engaged assembly allows for easy carry, protecting both the user and the tool tip. The assembly can be easily disassembled for parts replacement and cleaning

### BACKGROUND

The use of small every-day-carry pocket tools is very popular. Most small pocket tools that are carried, including capacitive styli, either have sharp tips that can cause injury when carried or soft tips that are easily damaged when carried in the user's pocket or travel bag.

Some solutions have been developed to solve these issues for individual tools that typically involve concealing by folding the tool into a concealed pocket, but this often leaves the tool with bulky apparatus attached to the tool when in use. The bulkiness of these tools often makes them less ergonomic and harder to use.

Other prior means of small pocket tool protection include fabric or leather sheaths, but they are also often bulky and often do not provide a mechanical means of attachment to the tool. This often leads to the tools parting from the intended holder, exposing the tool tip to damage or injury to the user.

Yet other means include slide on caps, but they also tend to easily disengage from the tool when carried in one's pocket, leading to potential injury or tip damage. This method is also limited by the design of the tool and cannot be used with tools with contoured grips or tool shape.

### BRIEF SUMMARY OF THE INVENTION

The present invention solves the pocket tool tip protection issue with a locking quick release cap that attaches to the tool by means of a spring loaded socket cap and retaining groove on the tool. This assembly allows for unlimited tool designs with conventional or irregular contoured grips on the tool because the attachment point is at the tip, rather than the barrel or body of the tool.

This invention allows for new ways to carry everyday pocket tools and styli, reducing user injury and tool tip damage. The device also allows for many possible ways of carrying the tools, including attachment to a lanyard, key ring, belt clip, simply as a protective cap or any other similar means.

### BRIEF DESCRIPTION OF THE DRAWINGS

The invention can be more fully understood by reading the subsequent detailed description and examples with references made to the accompanying drawings, wherein:

FIG. 1. Shows an orthographic view of the tool and locking quick release cap assembly as disclosed, with the tool (stylus) disengaged from the locking quick release protective cap.

FIG. 2. Illustrates a cross section through tool and locking quick release cap assembly as disclosed, with the tool engaged in the locking quick release protective cap. This view shows the inner spring and slide mechanism of the locking cap.

FIG. 3. FIG. 3 represents an exploded orthographic view of all the components that comprise the full assembly of the locking quick release cap and tool tip as disclosed.

### DETAILED DESCRIPTION AND BEST MODE OF IMPLEMENTATION

It should be noted that the drawings are not to scale and are instead used to illustrate the invention and how it works. All reference numbers refer to the same parts in the various drawings.

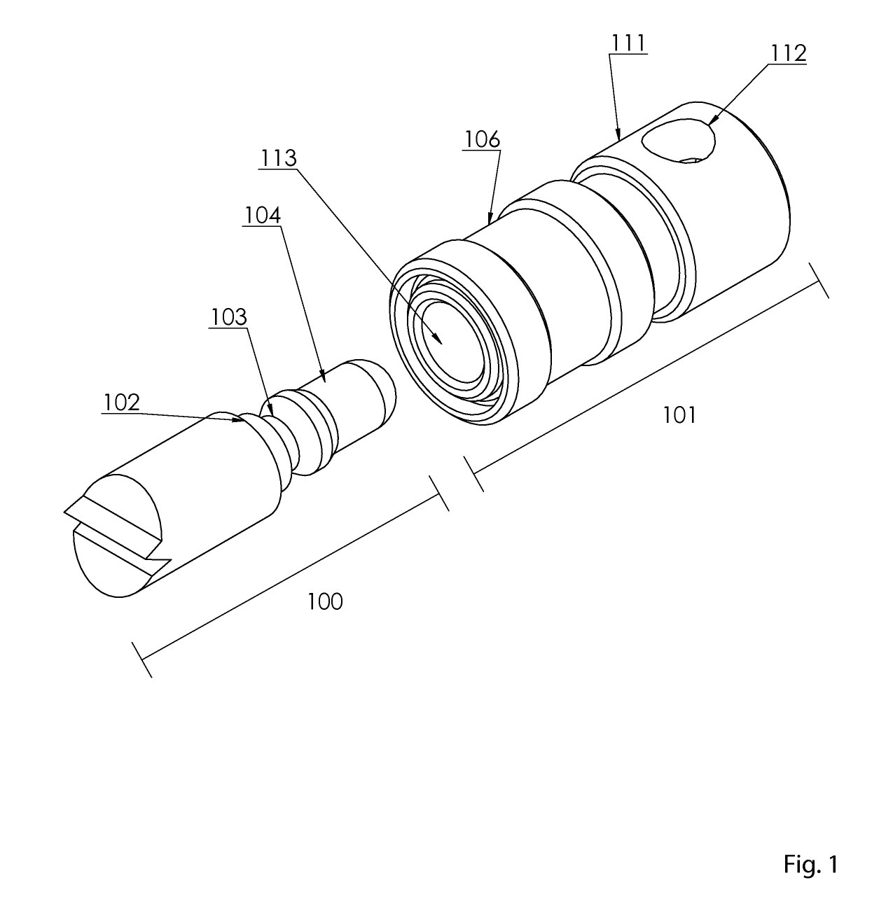

As shown in FIG. 1, a locking quick release protective tool cap assembly comprised of a grooved male tool component 100 and a female locking quick release protective cap assembly 101, where the female assembly is composed of a tubular body 111, acting as a protective tool cap and an outer locking slide 106 that acts as a means of locking and releasing the male tool component 100. The full assembly may be attached to a lanyard or similar apparatus through hole 112 for purposes of transporting the assembly in ones pocket, key ring, bag or similar means. The tool component 100 can be of any conventional tool or stylus construction and may include various types of tool tips 104 as is well known in the art, but must include the retaining groove 103. The female assembly 101 can be comprised of any conventional tool construction material, such as aluminum, steel or other metal alloys. It should be noted that such configurations as disclosed are exemplary only, and not intended to limit the scope of the disclosure thereto.

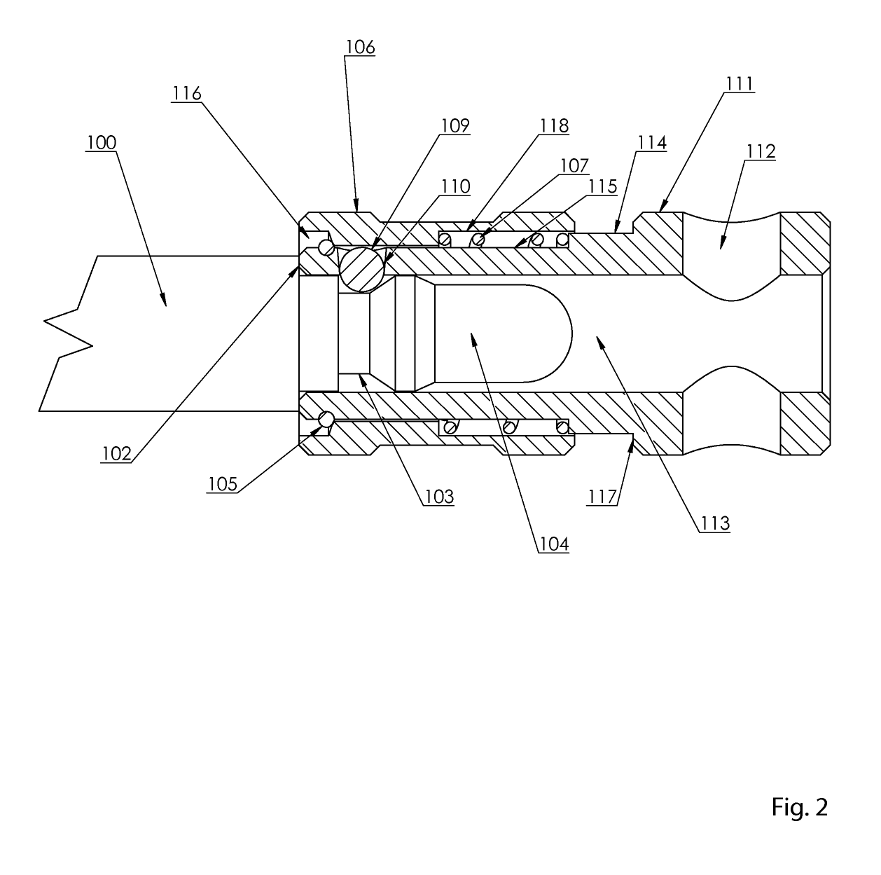

FIG. 2 is a cross section of the assembly including the male tool component 100 engaged in the female locking quick release protective cap assembly 101 as disclosed, showing outer locking slide 106 which is retained on the inner stepped slide 114 by retaining ring 105. The outer slide is held in the locked position by spring 107 which is retained between the machined step 115 on the inner stepped slide 114 and the machined step 118 in the outer locking slide 106. When the outer locking slide 106 is slid longitudinally along the tubular body 111 toward the stepped slide stop 117, retaining ball 109 is freed to travel into the unlock retaining groove 116 in the outer locking slide 106 when male tool component 100 is pulled out of the inner tube 113 portion of the tubular body 111. Insertion of the male tool tip 104 is achieved by sliding the outer locking slide 106 toward stepped slide stop 117, allowing retaining ball 109 to travel into unlock retaining groove 116 when male tool tip 104 contacts the retaining ball 109. When the male tool tip 104 is fully inserted into inner tube 113, to the tool insertion stop 102 and the outer slide 106 is released to slide toward retaining ring 105 from the pressure of spring 107, a portion of retaining ball 109 is forced into retaining groove 103 by outer locking slide 106. The retaining ball 109 is kept from passing completely through tubular body 111 by a tapered hole 110 that is wide enough to allow enough of the retaining ball 109 to engage into the retaining grove 103, but not pass all the way through.

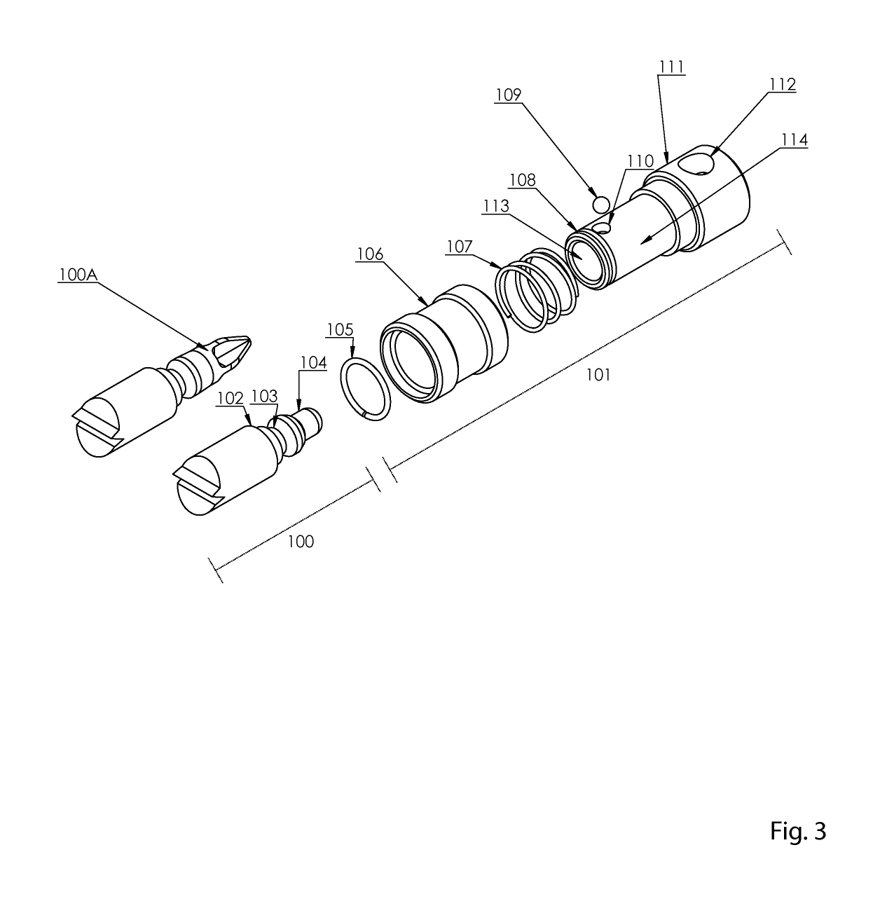

FIG. 3 shows the embodiment of the locking quick release protective cap assembly through an exploded orthographic view of the components comprising the complete assembly. Tool component 100 and 100A indicate possible variations in tool tips that could be used with the locking quick release protective cap 101. FIG. 3 also indicates that through the removal of retaining ring 105 from retaining ring groove 108, the quick release cap can be easily disassembled for part replacement should parts become worn or require cleaning for functionality.

The locking quick release cap assembly disclosed, allows for a fully functional mechanical locking cap system for use on styli or small pocket tools that is user friendly and provides protection for both the user and the tool tip. This system allows for many variations in tool tip design ranging from screw drivers to capacitive styli for handwriting on touch screen devices. If the assembly is attached to a key ring or tool bag, it allows for quick change of the tool to be carried for use at any time.

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the claims should be accorded the broadest interpretation so as to encompass all such modifications and similar arrangements.

I claim:

1. A locking quick release protective cap assembly for pocket tools including writing instruments, comprising:
A male tool component with retaining groove and a locking quick release female protective cap, wherein the two pieces may be engaged or disengaged by means of sliding a spring loaded locking slide on the female assembly.
